(19) United States
(12) Patent Application Publication
(10) Pub. No.: US 2009/0010095 A1
(43) Pub. Date: Jan. 8, 2009

(54) Automatic device for mixing fluids, particularly paints or varnishes

(75) Inventors: Mario Drocco, Alba (CN) (IT); Luca Drocco, Alba (CN) (IT); Matteo Drocco, Alba (CN) (IT)

Correspondence Address: MERCHANT & GOULD PC, P.O. BOX 2903, MINNEAPOLIS, MN, 55402-0903, US

(73) Assignee: DROMONT S.p.A., Grinzane Cavour (CN) (IT)

(21) Appl. No.: 11/906,657

(22) Filed: Oct. 3, 2007

(30) Foreign Application Priority Data
Oct. 4, 2006 (IT) TO2006A000710

(51) Int. Cl. B01F 15/02

(52) U.S. Cl. 366/132

(57) ABSTRACT

The invention relates to an automatic device for mixing fluids, particularly paints or varnishes, that are to be sent on to one or more mixing containers (9), said device comprising a plurality of circuits (1), independent of one another, and in particular a circuit (1) for each fluid being dosed, each circuit (1) comprising a storage tank (2) for storage of the fluid, a pump (4) for taking in the fluid from said storage tank (2) and for delivery thereof into said mixing container (9), valves, pipes, and an automatic-control device, also comprised in which are a plurality of precision circuits (1′), each one of which associated in parallel to each of said circuits (1), each of said precision circuits (1′) sharing with the associated circuit (1) the same storage tank (2) and the same automatic-control device and further comprising a precision pump (4′) for taking in the fluid from said storage tank (2) and for delivery thereof into said mixing container (9), as well as valves and pipes of their own.

### BACKGROUND OF THE INVENTION

The present invention concerns an automatic device for mixing fluids, particularly paints or varnishes, commonly indicated by the name of “tintometer”.

The invention relates to the field of preparation at an industrial level or retail level of formulations for paints and inks, which can be obtained by automatic mixing of pre-set amounts of different colours.

### SUMMARY OF THE INVENTION

More in particular, the invention concerns the possibility of preparing paints guaranteeing the high yields and productivity typical of tintometers present in retail outlets and at the same time the levels of precision required for sampling/laboratory machines with just a single machine, which enables saving in space and simplifies the work of operators, who do not need to maintain two machines.

In the present invention, when referring to the fluid being dosed reference will be made in particular to paint products and varnishes, but it is to be understood that the device can equally be used for different applications, such as, for example, for dosage of pharmaceutical products, cosmetics, aromas or perfumes.

Currently known and widely available on the market are different types of devices for dosage of fluids to be conveyed in pre-set amounts within a mixing container. These devices are used in particular for determining and controlling the amount of base colours to be mixed together to obtain a paint with desired chromatic characteristics.

More in particular, these devices are made up of a plurality of separate circuits, one for each different colour to be mixed, each circuit being constituted by a tank for storage of a given base paint or colorant, by a pump for taking colour out of the storage tank and for sending it into the mixing container, and possibly by pipes (present in a reduced form in certain models of machines) and control valves.

In addition, each circuit can envisage an independent dispenser of its own (a solution generally suitable in the case of systems that treat smaller amounts of fluids), directly in the proximity of the mixing container, or else one and the same dispenser can serve a number of circuits (a solution often adopted for systems that treat large amounts of fluids).

Automatic dosage devices of a known type are frequently equipped with a control system, which supervises operation of each circuit and in which a plurality of colour formulations are stored, in such a way that it is possible to set simply the final desired formulation, identified uniquely through a name or a code, as well as its amount, and leave the device the job of automatic selection of the relative amounts of the different colours that concur to make up the formulation.

Currently, the devices commonly available on the market may be divided in tintometers designed for the preparation of large amounts of products within paint stores, and sampling devices, which are also present in retail outlets, or laboratory devices, designed, instead, for production of sample products. Whereas the devices of the first type are required in particular to be simple, fast and to present low operating costs, the sampling devices above all need not, instead, be very precise. On the other hand, production devices are not able to produce small amounts of product with the required dosing precision, whereas sampling devices are not suitable for the production of large amounts of products, since, in order to be able to guarantee said amounts, they would require very long times.

This renders both of these classes of dosage devices unsuited to meeting market needs. In fact, in particular in the field of paints and varnishes, before deciding what formulation of paints to buy (presumably in large amounts), there is an ever-increasing request on the part of purchasers to be able to assess the effective colour yield of the paint product on the surface to which it is to be applied. For this purpose, the colour cards and samples commonly in use, whether electronic or in reams of paper or plastified strips represented on which are a multiplicity of colours set alongside one another, may not constitute a satisfactory solution, both on account of the extremely reduced dimensions that distinguish them and on account of the different chromatic effect that is obtained on the display or else from printing on paper as compared to the one obtained painting a wall or other objects of a different nature for which the paint product is to be used.

At the most, colour cards and samples can perform a function of enabling preselection of a certain number of colour formulations that are similar to one another, leaving to the subsequent application on the object that is to be painted the effective choice of the colour with the best aesthetic yield.

In this context there hence arises the need of being able to produce preliminarily small amounts of a formulation of which it will subsequently be necessary to produce large amounts.

Said characteristic renders necessary the possibility of having available a single system capable of reproducing faithfully a paint formulation, both at a production level and for small samples, with the advantage of a smaller occupation of space (which represents a high cost in retail outlets) and a greater simplicity for the operator, who can meet all the needs with just a single machine.

The above and other results are obtained according to the present invention by proposing an automatic device for dosage of fluids, in particular paint products or varnishes.

Further preferred characteristics of the automatic device for dosage of fluids, in particular paints or varnishes, according to the present invention, are specified.

### BRIEF DESCRIPTION OF THE DRAWINGS

The invention will be described in what follows by way of illustrative, but non-limiting, example, according to a preferred embodiment thereof, with particular reference to the figures of the attached plates of drawings, in which:

FIG. 1 shows a flowchart of a colour circuit of a device for dosage of fluids according to an embodiment exemplifying the known art; and

FIG. 2 shows a flowchart of a colour circuit of a device for dosage of fluids according to the present invention.

### DETAILED DESCRIPTION OF THE PREFERRED EMBODIMENTS

In the figures the standardized icons for graphic representation of hydraulic systems are used.

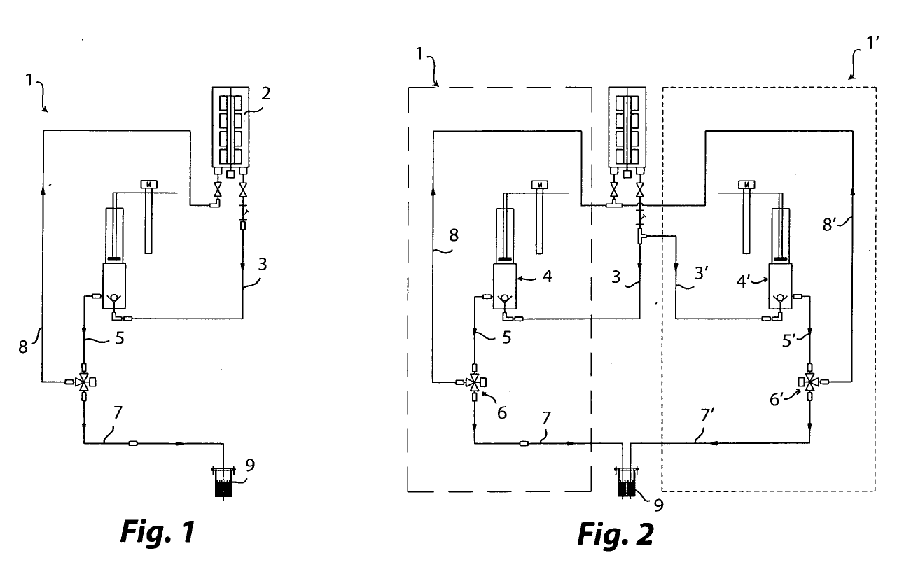

With preliminary reference to FIG. 1, a colour circuit 1 of a device for dosage of fluids according to the known art comprises a storage tank 2, inside which a given base paint or colorant is contained, which, together with other paints dedicated to which are circuits identical or similar to the one illustrated, concurs to obtain the formulation of the end product.

Departing from the storage tank is an intake pipe 3, which connects the storage tank 2 to the intake of a pump 4. The delivery of the pump 4 in turn traverses a delivery pipe 5 and reaches a three-way valve 6 electrically controlled by the automatic managing system (not shown). The function of the three-way valve 6 is that of dividing the flow that reaches the pump 4 between a dosage line 7 and a recirculation line 8, in this way guaranteeing the constancy of the flow that traverses the valve 6. In fact, if the needs of formulation require the flow directed to the dosage line 7 (and through this to the mixing container 9) to be smaller than the flow of the delivery of the pump 4, the three-way valve 6 directs the flow in excess to the recirculation line 8 and, through this, to the storage tank 2.

With reference to FIG. 2, it is shown how, according to the present invention, set alongside a circuit 1 of the known type, as has been already shown with reference to FIG. 1 and designated in its components using the same reference numbers, is a second circuit 1′, identical to the first in its components (designated with corresponding reference numbers bearing the prime sign) but different as regards the characteristics in terms of diameter of the various pipes, rate of movement of the product inside the circuit, dimension of the pump and precision of control of the three-way valve.

In particular, if the first circuit 1 is a circuit with standard characteristics of production, the second circuit 1′ will present the characteristics of a laboratory circuit, capable of guaranteeing high precision even if for reduced amounts of product obtained.

According to the present invention, the second circuit 1′ is normally inactive and intervenes only when the amounts required are below a minimum value and consequently the production circuit 1 is not able to guarantee the necessary precision. The task of determining the cases in which activation of the second circuit 1′ is required is entrusted to the automatic-control system.

The second high-precision circuit 1′, albeit with reference to a specific calibration set which enables the maximum precision in the working interval below the minimum operating threshold, in compliance with the specifications of precision required, of the first circuit 1, is not associated to a completely independent circuit, but shares with the first circuit 1 the storage tank 2.

When the relative amount of a colour required in order to obtain a given absolute amount of final formulation is lower than the minimum threshold that can be managed with precision by the first circuit 1, the automatic-control system of the device drives automatically the dosage actuator at the maximum resolution, with ramps of acceleration and deceleration purposely determined to obtain a minimum dosed volume, which can for example be equal to 1/768 of an ounce (equal to 0.038 cm³) or even lower values.

The dimensions of the very small passages (useful diameter of 2 mm or less according to the varnishes) enables a good separation of the product once the dosage has terminated and guarantees a repeatable precision.

Represented on the next page is a table that illustrates purely by way of example three examples of formulations identical to one another as regards the ratio between the amounts of base colours that concur to make up the end result, but different in the absolute amounts of formulation required and consequently in the amounts of the individual components.

TABLE

| | Product | | | | |
|---|---|---|---|---|---|
| | (specific | | | | |
| | weight = | Quantity | Quantity | Precision | Precision |
| Formula | 1) | (weight) | (weight %) | (weight) | (weight %) |
| Formula | A | 7 kg | 70% | 70 g | 1% |
| 1 | | | | | |
| | B | 2.5 kg | 25% | 25 g | 1% |
| | C | 0.4 kg | 4% | 4 g | 1% |
| | D | 0.05 kg | 0.5% | 0.5 g | 1% |
| | E | 0.05 kg | 0.5% | 0.5 g | 1% |
| Formula | A | 0.7 kg | 70% | 7 g | 1% |
| 2 | | | | | |
| | B | 0.25 kg | 25% | 2.5 g | 1% |
| | C | 0.04 kg | 4% | 0.4 g | 1% |
| | D* | 0.005 kg | 0.5% | 0.05 g | 1% |
| | E* | 0.005 kg | 0.5% | 0.05 g | 1% |
| Formula | A | 0.14 kg | 70% | 1.4 g | 1% |
| 3 | | | | | |
| | B | 0.05 kg | 25% | 0.5 g | 1% |
| | C | 0.008 kg | 4% | 0.08 g | 1% |
| | D* | 0.001 kg | 0.5% | 0.01 g | 1% |
| | E* | 0.001 kg | 0.5% | 0.01 g | 1% |

In particular, the total amount required for Formula 1 is such that the dosage of all the components required can conveniently be made through the circuit 1 at a high production rate, whilst the total amount required by Formula 1′ is such that the quantity required of the components D and E cannot be managed with the necessary precision by the high-rate circuit 1 and requires activation of the second high-precision circuit 1′.

In the table indicated by an asterisk are the products for which activation of the second high-precision circuit 1′ is necessary.

There emerges clearly the effectiveness of the automatic device for dosage of fluids according to the present invention, in which the automatic-control system, through controlled activation automatically and separately for each line of colour of the high-production-rate circuit or else of the high-precision circuit, enables the yields typical of the dosage devices used for production and the precision typical of laboratory dosage devices to be obtained simultaneously.

This has undoubtedly the advantage of being able to meet with a single machine both the production needs and the needs for sampling and laboratory, whereas currently two distinct machines are, instead, required; hence additional advantages are afforded such as saving in space, single maintenance operations both at a mechanical level and at a computer level. For example, updating of the formulations is to be made just on a single processor connected to the automatic-control device instead of on two different processors, one for each machine, thus preventing updating errors from occurring, due to the other than perfect alignment between the two processors.

In addition, the dosage device according to the present invention makes it possible to obtain, also in a production context (retail stores or dye-works or paint factory) where this is necessary, the higher precision afforded by the technology specifically devised for sampling or for laboratory uses, in particular in the cases where in the formulation that it is desired to obtain, for one or more ingredients it is necessary to obtain high quantities, precision and tolerances, which are difficult to achieve with a production machine according to the known art.

The present invention has been described by way of illustrative, but non-limiting, example, according to its preferred embodiments, but it is to be understood that variations and/or modifications may made by persons skilled in the branch without thereby departing from the corresponding sphere of protection, as defined by the annexed claims.

1. An automatic device for mixing fluids, particularly paints or varnishes, that are to be sent on to one or more mixing containers of different formats, including the sampling ones, said device comprising a plurality of circuits, independent of one another, and including a circuit for each fluid being dosed, each circuit comprising a tank for storage of the fluid, a pump for taking in the fluid from said storage tank and for delivery thereof into said mixing container as well as an automatic-control device, said dosage device comprising a plurality of precision circuits, each one of which is associated in parallel to each of said circuits, each of said precision circuits sharing with the associated circuit the same storage tank and the same automatic-control device and further comprising a precision pump for taking in the fluid from said storage tank and for delivery thereof into said mixing container so as to guarantee high performance of production and precision with a single machine.

2. The automatic device for mixing fluids according to claim 1, wherein said circuit and said precision circuit associated thereto comprise, respectively, an intake line and a precision intake line, which connect said storage tank, respectively, to said pump and to said precision pump, a delivery line and a precision delivery line, which convey the delivery of the respective pumps to respective valves, and a dosage line, associated to the outlet of said valve and, respectively, a precision dosage line, associated to the outlet of said precision valve.

3. The automatic device for mixing fluids according to claim 2, wherein said valves are three-way valves, respectively associated to the outlets of which are a dosage line and a recirculation line and, respectively, a precision dosage line and a precision recirculation line.

4. The automatic device for mixing fluids according to claim 1, wherein said automatic control system determines the relative amount of fluid necessary for dosage and consequently determines opening of the valves of said circuit, or else, for values lower than the minimum threshold that can be managed by said circuit with the necessary precision, of said precision circuit.
